(19) United States
(12) Patent Application Publication
(10) Pub. No.: US 2026/0166843 A1
(43) Pub. Date: Jun. 18, 2026

(54) MULTI-LAYER FLEXIBLE STRETCH/SHRINK FILM FOR TRAY OVERWRAP

(71) Applicant: MULTILAYER FILMS LLC, Rockwall, TX (US)

(72) Inventor: Patrick Thomas, Rockwall, TX (US)

(73) Assignee: MULTILAYER FILMS LLC, Rockwall, TX (US)

(21) Appl. No.: 19/413,462

(22) Filed: Dec. 9, 2025

Related U.S. Application Data
(60) Provisional application No. 63/733,038, filed on Dec. 12, 2024.

(51) Int. Cl. B32B 7/028; B32B 27/08; B32B 27/30; B32B 27/32

(52) U.S. Cl. CPC B32B 7/028; B32B 27/08; B32B 27/306; B32B 27/32; B32B 2250/05; B32B 2250/24; B32B 2307/30; B32B 2307/518; B32B 2307/7376; B32B 2439/70

(57) ABSTRACT

A multi-layered thermoplastic polyolefin film having an improved combination of physical characteristics, and methods of making and use. The multi-layered film exhibits enhanced heat seal strength, improved shrinkage performance, flexibility, and versatility on packaging equipment. The addition of ethylene-vinyl acetate (EVA), which is crosslinked during the manufacturing process, contributes to improved bubble stability and provides a significantly wider operating window for use on various types of packaging equipment. Preferred five-layer embodiments of the film include: a core layer of very low-density polyethylene (VLDPE) blended with linear low-density polyethylene (LLDPE); two optional adjacent intermediate layers of EVA blended with VLDPE blended with LLDPE and additives; and two outer layers of EVA blended with VLDPE and additives.

### CROSS REFERENCE TO RELATED APPLICATION

This application claims the benefit of U.S. Provisional Application, Ser. No. 63/733,038, filed on 12 Dec. 2024. The co-pending provisional application is hereby incorporated by reference herein in its entirety and is made a part hereof, including but not limited to those portions which specifically appear hereinafter.

### FIELD OF THE INVENTION

The present invention relates to a heat-shrinkable, thermoplastic packaging film, and in particular, high-strength heat seal films such as for the food packing industry.

### BACKGROUND OF THE INVENTION

One distinguishing feature of a shrink film is the film's ability, upon exposure to a certain temperature, to shrink or, if restrained from shrinking, to generate shrink tension within the film. The manufacture of shrink films is generally accomplished by extrusion (single layer films) or coextrusion (multi-layer films) of thermoplastic resinous materials which have been heated to their flow or melting point from an extrusion or coextrusion die in, for example, either tubular or planar (sheet) form. After a post-extrusion quenching to cool by, for example, the well-known cascading water method, the relatively thick “tape” extrudate is then reheated to a temperature within its orientation temperature range and stretched to orient or align the crystallites and/or molecules of the material. The orientation temperature range for a given material or materials will vary with the different resinous polymers and/or blends thereof which comprise the material. However, the orientation temperature range for a given thermoplastic material may generally be stated to be below the crystalline melting point of the material but above the second-order transition temperature (sometimes referred to as the glass transition point) thereof. Within this temperature range, it is easy to effectively orient the material.

Returning to the basic process for manufacturing the film as discussed above, it can be seen that the film, once extruded (or coextruded if it is a multi-layer film) and initially cooled by, for example, cascading water quenching, is then reheated to within its orientation temperature range and oriented by stretching. The stretching to orient may be accomplished in many ways such as, for example, by “blown bubble” techniques or “tenter framing.” These processes are well known to those in the art and refer to orientation procedures whereby the material is stretched in the cross or transverse direction (TD) and/or in the longitudinal or machine direction (MD). After being stretched, the film is quickly quenched while substantially retaining its stretched dimensions to rapidly cool the film and thus set or lock-in the oriented molecular configuration. Of course, if a film having little or no orientation is desired, e.g., non-oriented or non-heat shrinkable film, the film may be formed from a non-orientable material or, if formed from an orientable material, may be “hot blown.” In forming a hot blown film, the film is not cooled immediately after extrusion or coextrusion but rather is first stretched shortly after extrusion while the film is still at an elevated temperature above the orientation temperature range of the material. Thereafter, the film is cooled by well-known methods. Those of skill in the art are well familiar with this process and the fact that the resulting film has substantially unoriented characteristics. Other methods for forming unoriented films are well known. Exemplary, is the method of cast extrusion or cast coextrusion which, likewise, is well known to those in the art.

After setting the stretch-oriented molecular configuration, the film may then be stored in rolls and utilized to tightly package a wide variety of items. In this regard, the product to be packaged may first be enclosed in the heat-shrinkable material by heat sealing the shrink film to itself where necessary and appropriate to form a pouch or bag and then inserting the product therein. If the material was manufactured by “blown bubble” techniques, the material may still be in tubular form, or it may have been slit and opened up to form a sheet of film material.

Alternatively, a sheet of the material may be utilized to over-wrap the product. These packaging methods are all well known to those of skill in the art. Thereafter, the enclosed product may be subjected to elevated temperatures by, for example, passing the enclosed product through a hot air or hot water tunnel. This causes the enclosing film to shrink around the product to produce a tight wrapping that closely conforms to the contour of the product. As stated above, the film sheet or tube may be formed into bags or pouches and thereafter utilized to package a product. In this case, if the film has been formed as a tube, it may be preferable to first slit the tubular film to form a film sheet and thereafter form the sheet into bags or pouches. Such bag or pouch forming methods, likewise, are well known to those of skill in the art.

The above general outline for manufacturing of films is not meant to be all-inclusive since such processes are well known to those in the art. For example, see U.S. Pat. Nos. 4,274,900; 4,229,241; 4,194,039; 4,188,443; 4,048,428; 3,821,182 and 3,022,543. The disclosures of these patents are generally representative of such processes and are hereby incorporated by reference.

Irradiation of an entire film or a layer or layers thereof may be desired so as to improve the film's resistance to abuse and/or puncture and other physical characteristics. Irradiation may be accomplished by the use of high-energy electrons, ultraviolet radiation, X-rays, gamma rays, beta particles, etc. Preferably, electrons are employed up to about 20 megarads (MR) dosage level. The irradiation source can be any electron beam generator operating in a range of about 150 kilovolts to about 6 megavolts with a power output capable of supplying the desired dosage. The voltage can be adjusted to appropriate levels which may be, for example, 1,000,000 or 2,000,000 or 3,000,000 or 6,000,000 or higher or lower. Many apparatuses for irradiating films are known to those of skill in the art. Cross-linking may also be accomplished chemically through the utilization of peroxides as is well known to those of skill in the art.

The polyolefin family of shrink films and, in particular, the polyethylene family of shrink films provide a wide range of physical and performance characteristics such as, for example, shrink force (the amount of force that a film exerts per unit area of its cross-section during shrinkage), the degree of free shrink (the reduction in linear dimension in a specified direction that a material undergoes when subjected to elevated temperatures while unrestrained), tensile strength (the highest force that can be applied to a unit area of film before it begins to tear apart), heat sealability, shrink temperature curve (the relationship of shrink to temperature), tear initiation and tear resistance (the force at which a film will begin to tear and continue to tear), optics (gloss, haze and transparency of material), elongation (the degree the film will stretch or elongate at room temperature), elastic memory (the degree a film will return to its original unstretched (unelongated) dimension after having been elongated at room temperature), and dimensional stability (the ability of the film to retain its original dimensions under different types of storage conditions).

Film characteristics play an important role in the selection of a particular film and they differ for each type of packaging application and for each type of package. Consideration must be given to the product size, weight, shape, rigidity, number of product components and other packaging materials which may be utilized along with the film material and the type of packaging equipment available.

Heat-shrinkable polyolefin films having improved abuse resistance are known in the art. Recent developments include the film described in U.S. Pat. No. 4,617,241, which has provided a satisfactory combination of desired physical characteristics in that the film evidences a new and improved combination of physical characteristics, e.g., heat shrinkability, elongation, elastic memory, heat sealability, and abuse resistance (puncture resistance and resistance to tear propagation). However, while these recent films have proven useful in stretch/shrink packaging applications, certain applications require a film that offers enhanced low-temperature heat seal initiation, superior heat seal strength, improved elongation, better abuse resistance, and a lower modulus (i.e., greater flexibility). This film would also preferably exhibit a lower shrink temperature and a broader shrink temperature range, allowing for reduced energy consumption during the shrinking process. With a significantly broader operating range on packaging equipment, converters can rely on a single film for all packaging needs, eliminating the need to segregate films by customer.

### SUMMARY OF THE INVENTION

The invention provides a flexible, heat-shrinkable thermoplastic packaging film having a desirable combination of physical characteristics such as elongation, abuse resistance, flexibility, and heat shrinkability.

The invention includes a heat-shrinkable, thermoplastic packaging film, including a core layer including an ethylene-alpha-olefin copolymer and two outer layers, each on an opposing side of the core layer. Each outer layer includes a polymer blend of an ethylene-alpha-olefin copolymer and a second polymer, such as an ethylene copolymer, selected from one of: ethylene-vinyl acetate (EVA), ethylene methyl acrylate (EMA), ethylene-butyl acrylate (EBA), ethylene acrylic acid (EAA), an ionomer, and combinations thereof. The film is biaxially oriented and crosslinked, and is leak proof at more than 12 psi, desirably at more than about 15 psi, and more desirably at more than about 18 psi.

The film of this invention exhibits a broad operating window, sealing and shrinking effectively across a full range of temperatures commonly used in poultry tray overwrap operations. Current commercial films generally require narrow sealing and shrinking conditions, often forcing packagers to adjust equipment settings or maintain different film SKUs for different customers. Higher-melt-index ethylene copolymers in the outer layers, combined with controlled crosslinking (e.g., irradiation) provides melt strength for orientation while retaining flowability. This allows the sealant to conform and caulk around wrinkles, folds, and tray corners, producing consistent, leak-resistant seals even at lower sealing temperatures where other films perform poorly.

In embodiments the film has a total thickness of 7 to 25 microns, and/or a minimum of three layers (outer/core/outer). The film is made on a multi-manifold coextrusion die with no feedblock and no laminations. Each layer can be formed with a single die channel (one layer), or multiple identical die channels (multiple identical sub-layers). When an extruder melt stream is routed to more than one channel, the flow splits equally due to symmetrical channel design. This produces two or more sub-layers of identical composition and, generally, substantially equal thickness. Thus the 3-layer architecture of the film can include 5, 7, 9, 11, or more sub-layers without changing the inventive structure.

In embodiments, the core layer includes a very-low-density polyethylene (VLDPE), a linear low-density polyethylene (LLDPE), or a combination blend thereof. In presently preferred embodiments, the core layer comprises a metallocene VLDPE, a metallocene LLDPE, or a combination blend thereof.

The core layer desirably forms 40-90% of a total film thickness, and the two outer layers form 10-25% of the total film thickness. In presently preferred embodiments, the core layer forms about 60% of a total film thickness, and each of the two outer layers forms about 20% of a total film thickness.

Benefits provided by the film of this invention can be obtained by a balance of ethylene copolymer amount (e.g., VA wt. %) and controlled crosslinking. Each outer layer desirably includes an ethylene copolymer in an amount effective to promote heat-sealability. In embodiments, each of the two outer layers includes 0.7% to 3% by wt. of vinyl acetate, methyl acrylate, butyl acrylate, acrylic acid, or combinations thereof. This amount can be considered the final, or effective weight percent, as compared to the weight percent of the starting material of the ethylene copolymer in the outer layer blend. Preferably, the ethylene copolymer used in the two outer layers has a melt index (ASTM D1238) of greater than about 1, desirably greater than about 2, and more desirably about 2 to 5.

Any of various crosslinking methods can be used, including electron-beam irradiation, ultraviolet irradiation, chemical crosslinking, or combinations thereof. In presently preferred embodiments, the film is crosslinked by irradiation at a dosage of about 2 to about 8 megarads (MR).

The film is desirably biaxially oriented, such as via a bubble orientation or a tenter frame. The bubble orientation can be accomplished by a blown-bubble, double-bubble, or triple-bubble process, as are known in the art.

In embodiments, at least one layer includes an additive selected from slip agents, antiblock agents, processing aids, or combinations thereof. Each of the two outer layers desirably includes a slip agent, an anti-block agent, or combinations thereof. Outer layers may be the only layer including antiblock additives. Slip additives may be included in all layers due to their migration toward the film surface, with the total slip level determined by the final film thickness and desired coefficient of friction.

The film can optionally include intermediate layers, such as at least one on each of an opposing side of the core layer and between the core layer and a corresponding one of the outer layers. Each intermediate layer can have the same or different polymers from the outer layers, such as a blend of an ethylene-alpha-olefin copolymer with at least one of EVA, EMA, EBA, EAA, or an ionomer, and without any anti-block additive. In embodiments, the core layer comprises about 60% of a total film thickness, each of the two intermediate layers comprises about 10% of a total film thickness and each of the two outer layers comprises about 10% of a total film thickness.

In embodiments, the multi-layer film includes: a core layer of VLDPE blended with LLDPE, and outer layers of a blend of EVA and VLDPE, and additives, wherein the EVA is at least partially crosslinked. Preferably, the multi-layer film is both oriented and irradiated to a dosage of about 2 to about 8 megarads (MR), thereby providing a film with improved heat seal strength, flexible processing conditions, and enhanced shrinkage performance. The film can optionally include two intermediate layers, each adjacent to the core layer, wherein each intermediate layer comprises VLDPE, LLDPE, and/or EVA. Each of the intermediate layers and/or the outer layers independently include at least one additive selected from the group consisting of: slip agents, anti-block agents, or mixtures thereof. In presently preferred embodiments, only the outer layers include anti-block.

Embodiments of this invention provide multi-layer stretch/shrink films including an interior layer of VLDPE blended with LLDPE, intermediate layers adjacent to the interior layer, each including a blend of VLDPE, LLDPE, and additives, and two outer layers, each including a blend of EVA, VLDPE, metallocene LLDPE plastomer, and additives. These specific layer compositions provide a unique combination of physical characteristics, including improved heat seal strength, shrinkage performance, and flexibility, while delivering a broader operating window for packaging equipment.

Embodiments of the invention provide a tray overwrap polyolefin film that offers significant improvements over prior art tray overwrap films, particularly in terms of performance, heat seal strength, and versatility.

Embodiments of the invention provide a polyolefin tray overwrap film that combines a desirable set of physical characteristics, including abuse resistance, elongation, flexibility, and improved heat seal strength, to meet the demanding requirements of modern packaging applications.

The invention further includes a multilayer polyolefin film that can be tailored for use as a tray overwrap, having an interior layer including a core layer of VLDPE blended with LLDPE; two adjacent intermediate layers of VLDPE blended with LLDPE and additives; and two outer layers of EVA blended with VLDPE and additives. This design is aimed at optimizing heat seal strength and shrinkage properties while enhancing machinability and versatility for a wide range of packaging needs.

The invention provides a film with a broader shrink temperature range, lower energy consumption during the shrinking process, and the flexibility to perform across various packaging conditions, enabling converters to rely on a single film for all customer packaging needs, eliminating the necessity of segregating films for different applications or customers.

The invention further includes a method of creating the film, including steps of: coextruding the core layer and the outer layers; at least partially crosslinking the film, such as by irradiation at a dosage of about 2 to about 8 megarads (MR); and biaxially orienting the film in a blown bubble or tenter frame process. In presently preferred methods, the ethylene copolymer used in extruded blend for the two outer layers has a melt index of 2 to 5, and 0.7% to 3% by wt. of vinyl acetate, methyl acrylate, butyl acrylate, acrylic acid, or combinations thereof.

Other objects and the broad scope of applicability of the present invention will become apparent to those of ordinary skill in the art from the details disclosed hereinafter. However, it should be understood that the following detailed description, which indicates several preferred embodiments of the present invention, is only given for purposes of illustration, as various changes and modifications well within the scope of the present invention will become apparent to those skilled in the art in light of the following description.

Unless specifically set forth and defined or otherwise limited, the terms “polymer” or “polymer resin” as used herein generally include, but are not limited to, homopolymers, copolymers, such as, for example, block, graft, random and alternating copolymers, terpolymers, etc., and blends and modifications thereof. Furthermore, unless otherwise specifically limited, the terms “polymer” or “polymer resin” shall include all possible symmetrical structures of the material. These structures include, but are not limited to, isotactic, syndiotactic, and random symmetries.

The term “melt flow” as used herein or “melt flow index” is the amount, in grams, of a thermoplastic resin which can be forced through a given orifice under a specified pressure and temperature within ten minutes. The value should be determined in accordance with ASTM D 1238.

The terms “outer” or “outer layer” as used herein mean a layer of a multi-layer film which normally comprises a surface thereof in a five-layer embodiment or at least lies outside of the intermediate and core layers.

The term “core” or “core layer” as used herein usually refers to an interior layer of a multi-layer film having an odd number of layers wherein the same number of layers is present on either side of the core layer. In films having an even number of layers, the core layer can be either of the two central layers.

The term “intermediate” or “intermediate layer” as used herein refers to an interior layer of a multi-layer film which is positioned between a core layer and an outer layer of said film.

The term “polyolefin” as used herein refers to polymers of relatively simple olefins such as, for example, ethylene, propylene, butenes, isoprenes, and pentenes; including, but not limited to, homopolymers, copolymers, blends, and modifications of such relatively simple olefins.

The term “polyethylene” as used herein refers to a family of resins obtained by polymerizing the gas ethylene, C₂H₄. By varying the catalysts and methods of polymerization, properties such as density, melt index, crystallinity, degree of branching and cross-linking, molecular weight, and molecular weight distribution can be regulated over wide ranges. Further modifications are obtained by copolymerization, chlorination, and compounding additives. Low molecular weight polymers of ethylene are fluids used as lubricants; medium weight polymers are waxes miscible with paraffin; and the high molecular weight polymers (generally over 6,000) are resins generally used in the plastics industry. Polyethylenes having densities ranging from about 0.900 g/cc to about 0.940 g/cc are called low-density polyethylenes, while those having densities from about 0.941 g/cc to about 0.965 g/cc and over are called high-density polyethylenes. The low-density types of polyethylenes are usually polymerized at high pressures and temperatures, whereas the high-density types are usually polymerized at relatively low temperatures and pressures.

The term “linear low-density polyethylene” (LLDPE) as used herein refers to copolymers of ethylene with one or more comonomers selected from C₄ to C₁₀ alpha olefins such as butene-1, octene, etc., in which the molecules thereof comprise long chains with few side-chain branches or cross-linked structures. The side branching, which is present, will be short compared to non-linear polyethylenes. LLDPE has a density usually in the range of from about 0.916 g/cc to 0.940 g/cc for film-making purposes. The melt flow index of LLDPE generally ranges from between about 0.1 to about 10 grams per ten minutes and preferably between from about 0.5 to about 3.0 grams per ten minutes. LLDPE resins of this type are commercially available and are manufactured in low-pressure vapor-phase and liquid-phase processes using transition metal catalysts.

The term “very low-density polyethylene” (VLDPE) is used herein to describe a linear ethylene-alpha-olefin copolymer having densities of generally between 0.890 and 0.915 grams/cubic centimeter, and produced by catalytic, low-pressure processes.

The term “ethylene vinyl acetate copolymer” (EVA) as used herein refers to a copolymer formed from ethylene and vinyl acetate monomers wherein the ethylene-derived units in the copolymer are present in major amounts, and the vinyl acetate-derived units in the copolymer are present in minor amounts.

An “heat shrinkable” material is defined herein as a material which, when heated to an appropriate temperature above room temperature (for example, 96° C.), will have a free shrink of 5% or greater in at least one linear direction.

All compositional percentages used herein are calculated on a “by weight” basis.

The terms “orientation” or “oriented” are used herein to generally describe the process step and resultant product characteristics obtained by stretching and immediately cooling a resinous thermoplastic polymeric material which has been heated to a temperature within its orientation temperature range so as to revise the intermolecular configuration of the material by physical alignment of the crystallites and/or molecules of the material to improve certain mechanical properties of the film such as, for example, shrink tension and orientation release stress. Both of these properties may be measured in accordance with ASTM D 2838-81. When the stretching force is applied in one direction, uniaxial orientation results. When the stretching force is applied in two directions, biaxial orientation results. The term oriented is also herein used interchangeably with the term “heat shrinkable” with these terms designating a material which has been stretched and set by cooling while substantially retaining its stretched dimensions. An oriented (i.e., heat shrinkable) material will tend to return to its original unstretched (unextended) dimensions when heated to an appropriate elevated temperature.

The term “about” as used herein refers to plus or minus 10%.

The term “consisting essentially of” is not meant to exclude slight percentage variations or additives and agents of this sort.

A “cross-linked” material as used herein shall be defined as a material which after refluxing in boiling toluene or xylene, as appropriate, for forty hours shall have a weight percent residue of at least 5 percent. A procedure for determining whether a material is cross-linked or not is to reflux 0.4 grams of the material in boiling toluene or another appropriate solvent, for example, xylene, for twenty hours. If no insoluble residue (gel) remains, the material is determined not to be cross-linked. If, after twenty hours of refluxing insoluble residue (gel) remains, the material is refluxed under the same conditions for another twenty hours. If more than 5 weight percent of the material remains upon conclusion of the second refluxing, the material is considered to be cross-linked. Preferably, at least two replicates are utilized.

A rad is the quantity of ionizing radiation that results in the absorption of 100 ergs of energy per gram of a radiated material, regardless of the source of the radiation. A megarad is 10⁶ rads. (MR is an abbreviation for megarad).

Free shrink should be measured in accordance with ASTM D 2732.

The elongation properties of the film should be measured in accordance with ASTM D 638.

The hydrostatic pressure tank seal integrity test is used herein for evaluating seal integrity under conditions representative of commercial tray-wrapping operations. Although not defined by a specific ASTM standard, this test is widely used in the packaging industry to assess the ability of heat-sealed films to resist leakage under applied hydrostatic pressure. In this method, sealed packages are completely submerged in a water-filled pressure chamber. The chamber is then pressurized to a predetermined internal pressure, typically within the range of 10 to 18 psi, to simulate elevated mechanical stresses on the package seals. The test continues until either (i) the package exhibits visible leakage in the form of gas or liquid release, or (ii) a specified time interval is reached without leakage. Seal failure is detected visually by observing the formation of bubbles or product leakage from any portion of the seal perimeter. Packages that exhibit no leakage at the specified pressure are considered to have passed the hydrostatic seal integrity test. This hydrostatic pressure test provides a rigorous comparative evaluation of heat-seal performance and is particularly useful for identifying seal defects such as channels, wrinkles, or incomplete sealing. Films of the present invention consistently withstand hydrostatic pressures of at least 10-12 psi, and in preferred embodiments up to 18 psi, without leakage, demonstrating superior seal integrity relative to commercially available shrink films.

Other objects and advantages will be apparent to those skilled in the art from the following detailed description taken in conjunction with the appended claims and drawings.

### BRIEF DESCRIPTION OF THE DRAWINGS

FIG. 1 shows a cross-sectional view of a preferred five layered embodiment of this invention.

FIG. 2 shows a poultry tray wrapped in a film according to one embodiment of this invention.

### DESCRIPTION OF THE PREFERRED EMBODIMENTS

The invention provides a multilayer, heat-shrinkable polyolefin film containing multiple polyolefin and heat-sealable copolymer layers that together achieve superior seal strength, shrink performance, and flexibility. The film includes EVA, EMA, EBA, EAA, and/or ionomer copolymers, crosslinked inline or post-extrusion by electron-beam (e.g., 2-8 MR), UV, or chemical means, and oriented 2-6 times in both directions.

Preferred embodiments include a 3 to 9 film layer structures (A/B/C, A/B/C/B/A, A/B/C/D/E/F/G) with layer ratios between Oct. 10, 1960/10/10 or 20/60/20, depending on design requirements. Films demonstrate leak-free sealing performance (e.g., ≥15 psi) with high clarity, toughness, and broad sealing windows.

A core layer includes at least one an ethylene-alpha-olefin copolymer, such as VLDPE blended with LLDPE. Optional intermediate layers may include VLDPE, LLDPE, and EVA copolymers. The outer layers include a polymer blend of an ethylene-alpha-olefin copolymer and an ethylene copolymer, such as EVA, EMA, EBA, EAA, and/or ionomer copolymers. Exemplary desirable EVA materials for use in the film making have a vinyl acetate (VA) content of 7-12%, a melt index of 2-5, and the resulting film layer has an effective VA amount in the outer layers of 1-3 wt. %. Exemplary desirable EMA materials for use in the film making have a methyl acrylate (MA) content of 6-10%, a melt index of 2-5, and the resulting film layer has an effective MA amount in the outer layers of 0.8-2.5 wt. %. Exemplary desirable EBA materials for use in the film making have a butyl acrylate (BA) content of 6-12%, a melt index of 2-5, and the resulting film layer has an effective BA amount in the outer layers of 1-3 wt. %. Exemplary desirable EAA materials for use in the film making have an acrylic acid (AA) content of 3-10%, a melt index of 2-4, and the resulting film layer has an effective AA amount in the outer layers of 0.5-2 wt. %.

An exemplary blend includes EVA and VLDPE or metallocene LLDPE blends that enhance sealability and optical properties. The ethylene copolymer (e.g., EVA) content ranges from 5% to 25% by weight per layer, with VA content between 0.7% to 3% and has an original melt index of 2-10. Exemplary crosslinking levels range from about 2 to 8 MR, and more desirably about 3-5 MR, to enhance toughness, abuse resistance, and seal reliability without sacrificing clarity or flexibility.

The multilayer heat-shrinkable film may be produced by conventional coextrusion, irradiation, and orientation techniques, with optional chemical or hybrid crosslinking systems. For coextrusion, polymeric resins and additives are blended and fed into multiple extruders corresponding to each distinct film layer. The melts are coextruded through a circular or annular die to form a tubular tape, quenched, typically by water cascade, water bath, or internal bubble cooling, to stabilize the film dimensions. Each layer is supplied by its own extruder. The film is crosslinked by suitable means to improve melt strength, toughness, and sealability. Crosslinking may be conducted inline or post-extrusion using electron-beam, ultraviolet (UV), or chemical systems. Inline crosslinking can be performed immediately after extrusion, while post-crosslinking can occur on wound rolls. Chemical crosslinking can be achieved with peroxide, silane, or moisture-curable systems. For orientation, the film is reheated below its melting point but above its glass transition temperature and biaxially oriented (2×-6×) using a bubble process. The oriented film is rapidly quenched to preserve orientation. The film may be surface-treated (corona, flame, or plasma) and slit into rolls for packaging use. Final films general exhibit a tensile strength of ≥20 kPSI, a modulus of 10-25 kPSI, haze≤5%, gloss>100, shrink onset of≈170° F., full shrink≈210° F., and leak-free seals ≥18 PSI over 130-220° C.

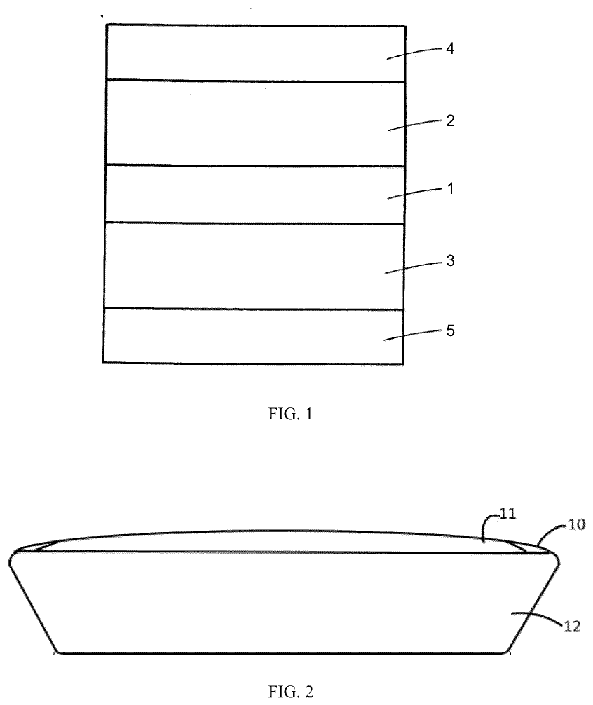

FIG. 1 shows a cross-sectional view of a preferred five-layered film of the present invention. Each of the five layers can be a single extruded or multi-extruded layer. FIG. 1 includes a core layer 1, two adjacent (and optional) intermediate layers 2 and 3, and two outer or skin layers 4 and 5. In embodiments, a presently preferred thickness ratio of the five layers is 1/1/6/1/1. This ratio can also be expressed as, where the core layer constitutes about 60% of the total film thickness, and each intermediate and outer layer contributes about 10%. FIG. 2 shows the film 10 of this invention used as a packaging wrap for a food tray 12, such as for poultry 11.

A preferred core layer 1 formulation includes a blend of VLDPE and LLDPE. Experimentation has revealed an especially preferred core layer formulation of VLDPE metallocene plastomer blended with LLDPE, which provides improved flexibility and shrink performance. Suitable VLDPE resins include Dow Chemical's AFFINITY PL1881, which is a metallocene-based plastomer having a density of approximately 0.904 g/cm³ and a melt flow rate (MFR) of about 1.0 g/10 min (condition E, ASTM D1238). Other VLDPE and LLDPE resins may be utilized to form core layer 1, such as those commercially available from ExxonMobil or other suppliers.

In embodiments, a preferred intermediate layer 2 and 3 formulation includes a blend of VLDPE, LLDPE, EVA, and additives. Preferred LLDPE resins include Nova® FP-120 CO2, which has a density of approximately 0.920 g/cm³ and a melt flow rate of about 1.0 g/10 min (condition E, ASTM D1238). Preferred EVA resins include Dow® Elvax 760, which has a density of approximately 0.930 g/cm³, a melt flow rate of about 2.0 g/10 min, and a vinyl acetate content ranging from 9.0% to 9.6%. Preferred VLDPE resins include Dow Chemical's AFFINITY PL1881, a metallocene-based plastomer with a density of approximately 0.904 g/cm³ and a melt flow rate of about 1.0 g/10 min (condition E, ASTM D1238).

With regard to outer layers 4 and 5, in presently preferred embodiments, the skin layer formulation desirably includes a blend of EVA and VLDPE metallocene plastomer. Both the outer layers and the intermediate layers 2 and 3 include crosslinked EVA, which provides excellent heat seal strength while maintaining good optics and processability. The crosslinking of EVA during the manufacturing process increases the melt strength, enabling the material to flow around wrinkles and folds during heat sealing. This enhanced flow allows the material to caulk potential pinholes, channel leakers, and wrinkles, ensuring a strong, leakproof seal.

The combination of crosslinked EVA in both the outer layers and intermediate layers contributes to a strong heat seal with low heat seal initiation and a wide operating window on various packaging equipment. This makes the film versatile and compatible with different packaging systems, while also improving bubble stability during the manufacturing process.

The EVA used in the outer layers may have a density at 23° C. of about 0.930 g/cm³ and a melt flow rate (measured by condition E) of about 2.0 g/10 min. Other ethylene-vinyl acetate copolymers or blends of two or more ethylene vinyl acetate copolymers may be utilized to form outer layers 4 and 5. Preferably, the composition of outer layers 4 and 5 is the same; however, different VLDPE resins or blends thereof, and different ethylene-vinyl acetate copolymers or blends thereof, may be utilized for each outer layer.

Additional slip and anti-block agents used in the formulation include AMPACET 807317, which is a high-clarity anti-block with 10% active content, providing excellent clarity and tight particle distribution in the skin at 2500 ppm. Another additive is AMPACET 103141, a cross-linked silicone bead with 5% active content in the masterbatch and 3750 ppm in the skin. This additive reduces COF and provides locked-in performance, serving as an anti-block but not a slip agent. Also included is AMPACET 10090, an erucamide slip agent with slow blooming characteristics, used with an LDPE carrier resin at 5% erucamide. Similarly, Ingenia 1065 is an erucamide slip agent (slow blooming), with an LLDPE carrier, and Standridge 87838, an erucamide slip agent (slow blooming), with 5% active content, a density of 0.924 g/cc, and a melt index of 20 MI.

The general ranges for the inclusion or application of these additives are as follows: silica ranges from 250 to 3000 ppm, erucamide ranges from 200 to 5000 ppm, and stearamide ranges from 200 to 5000 ppm.

Additional layers and/or minor amounts of additives of the types described above may be added to the film structure of the present invention as desired. However, care must be taken not to adversely affect the desirable physical properties and other characteristics of the inventive film.

Those skilled in the art will readily recognize that various modifications and variations can be made in the design and formulation of the film, as well as in the processing conditions, without departing from the scope of the invention as defined in the claims.

The specific five-layer film structure and material composition of this invention has demonstrated an improved combination of heat seal strength, abuse resistance, shrink performance, flexibility, and versatility making it particularly suitable for tray overwrap applications in the meat and poultry packaging industry.

Those skilled in the art will readily recognize that all of the disclosed, by weight, percentages are subject to slight variation. Additionally, these percentages may vary slightly due to the inclusion or application of additives, such as slip agents, anti-block agents, and other processing aids.

In a preferred process for making the multi-layer film of the present invention, the basic steps include coextruding the layers to form the multi-layer film, irradiating the film, and then stretching the film to biaxially orient it. These steps and other desirable steps will be explained in detail in the paragraphs that follow.

The process begins by blending, if necessary, the raw materials (i.e., polymeric resins) in the proportions and ranges discussed above. The resins are usually purchased from a supplier in pellet form and can be blended in any of the commercially available blenders, as is well known in the art. During the blending process, any desired additives and/or agents are also incorporated. The resins and applicable additives/agents are then fed to the hoppers of extruders, which feed a coextrusion die. For the preferred five-layer film, having two identical outer layers and two identical intermediate layers, at least three extruders are required: one for the two outer layers, one for the two intermediate layers, and one for the core layer. Additional extruders may be employed if a film with non-identical outer layers is desired.

The materials are coextruded as a relatively thick tube or “tape” which has an initial diameter dependent upon the diameter of the coextrusion die. The final diameter of the tubular film is dependent upon the stretching ratio. Circular coextrusion dies are well known to those in the art and can be purchased from a number of manufacturers.

An additional process step which can be utilized to manufacture the preferred embodiment of the presently inventive film is to irradiate the tape or unexpanded tubing or sheet by bombarding it with high-energy electrons from an accelerator to cross-link the materials of the tube. Cross-linking greatly increases the structural strength of the film or the force at which the material can be stretched before tearing apart when the film materials are predominately ethylene, such as polyethylene or ethylene vinyl acetate. Irradiation also improves the optical properties of the film and changes the properties of the film at higher temperatures. A preferred irradiation dosage level is in the range of from about 0.5 MR to about 12.0 MR. An even more preferred range is from about 2 MR to about 6 MR. The most preferred dosage level is approximately 4 MR.

Following coextrusion, quenching to cool and solidify, and irradiation of the tape, the extruded tape is reheated and inflated into a bubble by application of internal air pressure, thereby transforming the narrow tape with thick walls into a wide film with thin walls of the desired film thickness and width. After stretching, the tubular film is then collapsed into a superimposed lay-flat configuration and wound into rolls often referred to as “mill rolls.” The inflation process orients the film by stretching it transversely and longitudinally, thus imparting shrink capabilities to the film. Additional longitudinal or machine direction stretching may be accomplished by revolving the deflate rollers, which aid in the collapsing of the “blown bubble” at a greater speed than that of the rollers which serve to transport the reheated “tape” to the inflation or blown bubble area.

Preferred transverse and longitudinal stretching ratios of the present film range from about 2.5 transverse by about 3.0 longitudinal to about 5.0 transverse and about 5.0 longitudinal. A particularly preferred stretching ratio is about 4.8 transverse by about 4.8 longitudinal. All of these methods of orientation are well known to those of skill in the art.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

To further disclose and clarify the scope of the present invention to those skilled in the art, the following test data are presented. The samples were formed by coextrusion, irradiated and stretched (oriented) by application of internal air (bubble technique) in accordance with the teachings described above. That is, the five layer stretch/shrink films in accordance with the invention were produced by using three or four extruders feeding molten polymer into an annular die. The individual melt streams were brought together within the die and exited as a tube or tape. The single wall tube was quenched with water as it passed over a forming shoe. The tube was then collapsed and tracked through an irradiation unit where it received an about 4 megarads dosage. The tape was then reheated in an oven and biaxially oriented with a 4.8 by 4.8 stretch ratio in both the longitudinal and transverse directions. The film was double wound at the winder. These embodiments are hereinafter designated as Examples 1, 2, 3, and 4.

### Trial Design: All Layer Ratios 1/1/6/1/1 and Film Structures: A/B/C/B/A

Example 1:4.2 MR higher crosslinking
Example 2:4.0 MR crosslinking
Example 3:4.0 MR crosslinking; addition of Westlake® EVA EF437AA to the outer layer
Example 4:4.0 MR crosslinking; addition of Dow® Elvax 760 to the outer layer

### Example 1-4.8 Stretch Ratio; Higher Crosslinking (4.2 MR)

Layer A: 87.5% PL1880G; 2% POLYFIL PAC-0005FFLL-MWZ; 3% AMPACET 807317; and 7.5 AMPACET 103141
Layer B: 84% PL1880G; 15% FP120-CO2; and 1% POLYFIL PAC-0005FFLL-MWZ
Layer C: 82% PL1880G; 15% FP120-CO2; 1% POLYFIL PAC-0005FFLL-MWZ; and 2% INGENIA 1065/STANDRIDGE 87838/AMPACET10090
Layer B: 84% PL1880G; 15% FP120-CO2; and 1% POLYFIL PAC-0005FFLL-MWZ
Layer A: 87.5% PL1880G: 2% POLYFIL PAC-0005FFLL-MWZ: 3% AMPACET 807317:7.5 AMPACET 103141

### Example 2-4.8 Stretch Ratio; Lower Crosslinking (4.0 MR)

Layer A: 87.5% PL1880G; 2% POLYFIL PAC-0005FFLL-MWZ; 3% AMPACET 807317; and 7.5 AMPACET 103141
Layer B: 84% PL1880G; 15% FP120-CO2; and 1% POLYFIL PAC-0005FFLL-MWZ
Layer C: 82% PL1880G; 15% FP120-CO2; 1% POLYFIL PAC-0005FFLL-MWZ; and 2% INGENIA 1065/STANDRIDGE 87838/AMPACET10090
Layer B: 84% PL1880G; 15% FP120-CO2; and 1% POLYFIL PAC-0005FFLL-MWZ
Layer A: 87.5% PL1880G; 2% POLYFIL PAC-0005FFLL-MWZ; 3% AMPACET 807317; and 7.5 AMPACET 103141

### Example 3 (wt % VA-0.375% VA)-4.8 Stretch Ratio; Lower Crosslinking (4.0 MR)

Layer A: 74.5% PL1880G; 15% EF437AA; 2% POLYFIL PAC-0005FFLL-MWZ; 2.5% AMPACET 807317; and 6% AMPACET 103141
Layer B: 69% PL1880G; 15% FP120-CO2; 15% EF424AA; and 1% POLYFIL PAC-0005FFLL-MWZ
Layer C: 82% PL1880G; 15% FP120-CO2; 1% POLYFIL PAC-0005FFLL-MWZ; and 2% INGENIA 1065/STANDRIDGE 87838/AMPACET10090
Layer B: 69% PL1880G; 15% FP120-CO2; 15% EF424AA; and 1% POLYFIL PAC-0005FFLL-MWZ
Layer A: 74.5% PL1880G; 15% EF437AA; 2% POLYFIL PAC-0005FFLL-MWZ; 2.5% AMPACET 807317; and 6% AMPACET 103141

### Example 4 (wt % VA-1.395%)-4.8 Stretch Ratio; Lower Crosslinking (4.0 MR)

Layer A: 74.5% PL1880G; 15% Elvax 760; 2% POLYFIL PAC-0005FFLL-MWZ; 2.5% AMPACET 807317; and 6% AMPACET 103141
Layer B: 69% PL1880G; 15% FP120-CO2; 15% Elvax 760; and POLYFIL 1% PAC-0005FFLL-MWZ
Layer C: 82% PL1880G; 15% FP120-CO2; 1% POLYFIL PAC-0005FFLL-MWZ; and 2% INGENIA 1065/STANDRIDGE 87838/AMPACET10090
Layer B: 69% PL1880G; 15% FP120-CO2; 15% Elvax 760; and POLYFIL 1% PAC-0005FFLL-MWZ
Layer A: 74.5% PL1880G; 15% Elvax 760; 2% POLYFIL PAC-0005FFLL-MWZ; 2.5% AMPACET 807317; and 6% AMPACET 103141

The four experimental films were evaluated alongside competitive Cryovac® and Bollore® films using a standard tray overwrap packaging machine set up for Cryovac® conditions. Despite adjustments in sealing parameters, Examples 1-3 produced leaks under all tested conditions and failed to meet performance requirements. These three samples operated at a lower temperature range of about 110° C. to 120° C., contributing to their inadequate sealing. Example 3 fails due to a lower VA content in the EVA. In contrast, Example 4, incorporating Dow® Elvax 760 into its EVA blend, performed exceptionally well at seal temperatures ranging from 160° C. to 200° C., conditions comparable to Cryovac's. Example 4 served as a direct drop-in replacement for Cryovac® poultry film but also exhibited a significantly broader operating window, surpassing both the competitive films and the other experimental samples. It remained leak-free under both Cryovac® and Bollore® optimal conditions and maintained a secure seal at 15 and 18 PSI, representing a 63% increase over the current commercial average of 10-12 psi.

In addition, Example 4 achieved satisfactory shrink performance at a shrink temperature 30° F. lower than that required by the competitive films. Example 4, with a crosslinking level of just 4 MR, offered improved versatility, operating effectively under either set of competitor conditions without leaks and at reduced shrink temperatures, demonstrating superior overall.

TABLE 1
Physical Properties

| Physical Properties | Bollore ® | Cryovac ® | Example 4 |
|---|---|---|---|
| Thickness (μm) | 18 | 17 | 15.2 |
| Haze (%) | 3.9 | 5.6 | 5 |
| Gloss | 78 | 107 | 110 |
| Shrinkage MD/TD | 80/79 | 70/68 | 78/84 |
| Tensile MD/TD (PSI) | 15664/16224 | 14648/14938 | 22000/22000 |
| Elongation MD/TD (%) | 124/236 | 187/199 | 180/190 |
| Modulus (PSI) | 33963/34253 | 37710/35676 | 14000/16000 |
| COF | 0.51-0.47 | 0.43-0.34 | 0.23 |

Example 4 was thinner, offered higher tensile strength, and had the lowest COF and modulus, making it more flexible and easier to process. Overall, the film of Example 4 balances high strength, good optical properties, and improved processing versatility.

Thus the invention provides a flexible, heat-shrinkable thermoplastic packaging film having a desirable combination of physical characteristics such as elongation, abuse resistance, flexibility, and heat shrinkability. The film conforms and caulks around wrinkles, folds, and tray corners, producing consistent, leak-resistant seals even at lower sealing temperatures where other films perform poorly.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A heat-shrinkable, thermoplastic packaging film, comprising:
a core layer comprising an ethylene-alpha-olefin copolymer;
two outer layers, each on an opposing side of the core layer, and each comprising a polymer blend of an ethylene-alpha-olefin copolymer and a second polymer selected from one of: ethylene-vinyl acetate (EVA), ethylene methyl acrylate (EMA), ethylene-butyl acrylate (EBA), ethylene acrylic acid (EAA), an ionomer, and combinations thereof;
wherein the film is biaxially oriented and crosslinked, and is leak proof at 15 psi.

2. The film of claim 1, wherein the core layer comprises a very-low-density polyethylene (VLDPE), a linear low-density polyethylene (LLDPE), or a combination blend thereof.

3. The film of claim 2, wherein the core layer comprises a metallocene VLDPE, a metallocene LLDPE, or a combination blend thereof.

4. The film of claim 1, wherein the core layer comprises 40-90% of a total film thickness, and the two outer layers comprise 10-25% of the total film thickness.

5. The film of claim 4, wherein the core layer comprises about 60% of a total film thickness, and each of the two outer layers comprises about 20% of a total film thickness.

6. The film of claim 1, wherein each of the two outer layers comprise 0.7% to 3% by wt. of vinyl acetate, methyl acrylate, butyl acrylate, acrylic acid, or combinations thereof.

7. The film of claim 1, wherein the film is irradiated to a dosage of about 2 to about 8 megarads (MR).

8. The film of claim 1, wherein the second polymer used in the two outer layers comprises a melt index of 2 to 5.

9. The film of claim 1, wherein each of the two outer layers includes a slip agent, an anti-block agent, or combinations thereof.

10. The film of claim 9, further comprising two intermediate layers, each on an opposing side of the core layer and between the core layer and a corresponding one of the outer layers, wherein each intermediate layer comprises a blend of an ethylene-alpha-olefin copolymer with at least one of: EVA, EMA, EBA, EAA, or an ionomer, and without any anti-block additive.

11. The film of claim 10, wherein the core layer comprises about 60% of a total film thickness, each of the two intermediate layers comprises about 10% of a total film thickness and each of the two outer layers comprises about 10% of a total film thickness.

12. The film of claim 1, wherein the film is biaxially oriented via a bubble orientation or a tenter frame.

13. The film of claim 1, wherein the film has a total thickness of 7 to 25 microns.

14. The film of claim 1, wherein:
the core layer comprises a blend of VLDPE and LLDPE;
the two outer layers each comprise a blend of EVA and VLDPE, wherein the EVA is at least partially crosslinked;
wherein the film is biaxially oriented and irradiated to a dosage of about 2 to about 8 megarads (MR), thereby providing a film with improved heat seal strength, flexible processing conditions, and enhanced shrinkage performance.

15. The film of claim 14, further comprising:
two intermediate layers, each adjacent to the core layer, wherein each intermediate layer comprises VLDPE, LLDPE, and/or EVA.

16. The film of claim 15, wherein each of the intermediate layers and/or the outer layers independently include at least one additive selected from the group consisting of: slip agents, anti-block agents, or mixtures thereof.

17. A food container wrapped in the film according to claim 1.

18. A poultry tray including raw poultry wrapped in the film according to claim 1.

19. A method of food packaging, comprising wrapping raw poultry with the film of claim 1 and shrinking the film.

20. A method of creating the film of claim 1, the method comprising:
coextruding the core layer and the outer layers;
crosslinking the film by irradiation at a dosage of about 2 to about 8 megarads (MR); and
biaxially orienting the film in a blown bubble or tenter frame process.
